(19) United States
(12) Patent Application Publication
(10) Pub. No.: US 2020/0253249 A1
(43) Pub. Date: Aug. 13, 2020

(54) POPCORN POPPING MACHINE

(71) Applicant: Mansoor GHAZIZADEH, Portland, OR (US)

(72) Inventor: Mansoor GHAZIZADEH, Portland, OR (US)

(21) Appl. No.: 16/785,322

(22) Filed: Feb. 7, 2020

Related U.S. Application Data
(60) Provisional application No. 62/803,291, filed on Feb. 8, 2019.

(51) Int. Cl. A23L 7/183; A23L 7/191; A23G 3/20

(52) U.S. Cl. CPC A23L 7/183; A23G 3/20; A23L 7/191

(57) ABSTRACT

A popcorn popper for popping popcorn kernels includes a base section that includes an electrical blower that receives air from an inlet from a location exterior to the popcorn popper and provides air through an air outlet. A popping section that is positioned in a manner to receive the air provided through the air outlet of the base section and suitably sized for popping popcorn kernels in response to receiving sufficient heat together with the received air. A transfer section that receives the popped popcorn from the popping section that may optionally support popcorn and seasoning. A removable container that receives the popped popcorn from the transfer section.

### CROSS-REFERENCE TO RELATED APPLICATIONS

This application claims the benefit of U.S. Provisional Patent Application No. 62/803,291 filed Feb. 8, 2019.

### BACKGROUND OF THE INVENTION

One of the oldest and most common snacks in the world is popcorn. Typically, popcorn is made by cooking uncooked corn kernels, which expands and bursts the corn kernels into popped corn, which is often referred to as “popcorn.” Each of the corn kernels contains a small amount of water stored (e.g., approximately 13.5 to 14 percent moisture) within a layer of soft starch, the soft starch being surrounded by the corn kernel's outer surface of hard starch. The corn kernels heat up as heat is applied to each of the corn kernels, with the water within the corn kernels expanding which causes pressure to build against the hard starch. Eventually, the hard surface of hard starch gives way, causing each of the corn kernels to explode causing the soft starch inside the corn kernel to be inflated and burst which turns each of the corn kernels inside out. In general, the preferred popping temperature is between 400 and 460 degrees Fahrenheit.

Popcorn devices typically make popcorn using either “wet” or “dry” popping. Wet popcorn devices typically use a liquid, such as cooking oil to cook the corn kernels in and convert the corn kernels into the popped corn. Dry popcorn devices typically use hot air to cook the corn kernels in and convert the corn kernels into the popped corn. Another manner to make dry popcorn is using microwave popcorn, which is simple to use. However, microwave popcorn is not generally considered a healthy snack.

Dry popcorn devices are generally preferable over wet popcorn devices because they are more energy efficient, tend to pop the corn faster, and cleanup tends to be simpler. Dry popcorn devices often use hot air in some manner, and may include a combination of roasting, agitation, heating, and convection to convert the kernels into the popcorn, and expel the popcorn out of the popcorn maker.

Ishihara, U.S. Pat. No. 4,702,158, discloses a popcorn popper having a popping chamber, which has a plurality of radially arranged holes along a bottom periphery, a lower wall portion of gradually smaller diameter, and a bottom having a raised portion.

Friedman, U.S. Pat. No. 4,512,247, discloses a popcorn popping and coating machine, comprising a hot air popcorn popper having a discharge chute in communication with a rotary driven receptacle. The popping and coating machine also has a pivoting gate, which blocks passage of the popcorn through the discharge chute until the popper becomes filled with popped kernels, so that the kernels continue to be heated until the popcorn is introduced into a coating receptacle.

Tienor, U.S. Pat. No. 4,152,974, discloses a hot air popcorn popper having a body, which has a lower body portion closed by a removable cover, a hollow stainless steel popping vessel, which is removably held in the lower body portion, the hollow stainless steel popping vessel having a bottom end closed by a perforated grill, and a gravity flow feed hopper formed in the lower body portion, which provides automatic flow of unpopped kernels into the popping vessel, the unpopped kernels being contained on top of the perforated grill. An upwardly directed hot air flow produced in the lower body portion is directed through the popping vessel. The air flow pops the unpopped kernels and carries the popped kernels out of the popping vessel and the body to a storage receptacle.

The foregoing and other objectives, features, and advantages of the invention may be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a popcorn popper.

FIG. 2 illustrates a popcorn packet for the popcorn popper of FIG. 1.

FIG. 3 illustrates a seasoning packet for the popcorn popper of FIG. 1.

FIG. 4 illustrates a seasoning packet for the popcorn popper of FIG. 1.

FIG. 5 illustrates a modified portion of the popcorn popper of FIG. 1.

FIG. 6 illustrates a modified container.

FIG. 7 illustrates the modified container of FIG. 6.

FIG. 8 illustrates a modified popcorn popper.

### DETAILED DESCRIPTION OF PREFERRED EMBODIMENT

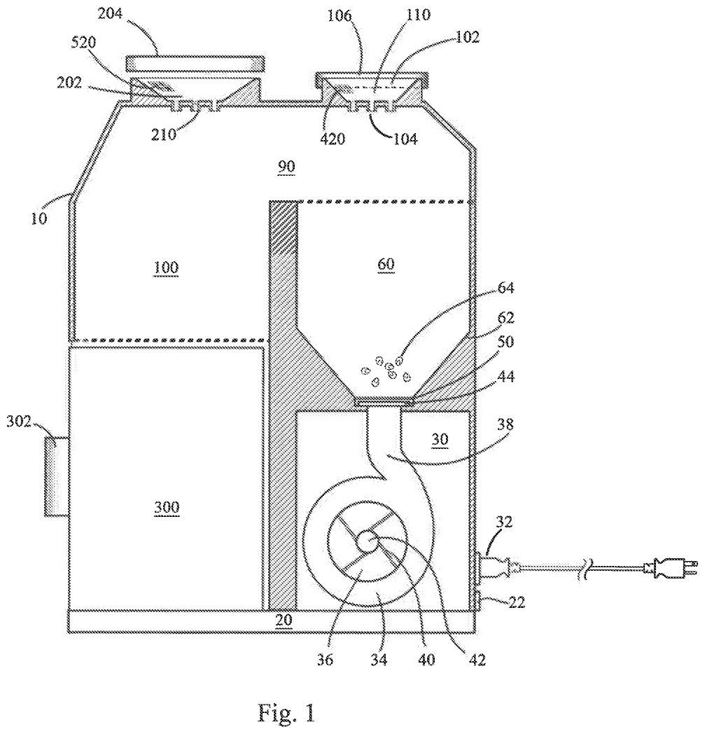

Referring to FIG. 1, a popcorn popper 10 is generally vertically oriented. The popcorn popper 10 may include a base 20 that supports the remainder of the popcorn popper. In this manner the base 20 may be used to support the entire popcorn popper 10 and move the popcorn popper 10 from one location to another. Preferably, the remainder of the popcorn popper 10 is readily removable from the base 20, such as by lifting or by releasing a pair of attachments 22, so that the base may be readily cleaned. The popcorn popper 10 may include a base section 30, that is preferably oval or circular in cross section. The base section 30 may include an electrical wire 32 for plugin to an electrical outlet. The base section 30 may include an electrical blower 34 that includes an integrated heater therein. The electrical blower 34 includes a lower air intake 36 and a higher air outlet 38. The lower air intake 36 brings in exterior air through openings in the base section 30. Rotation of a set of radially slanted vanes 40 mounted on a central hub 42 of the electrical blower 34 causes an air flow in the direction of the higher air outlet 38. The air exiting the higher air outlet 38 is preferably sufficiently heated, such as between 400 and 460 degrees Fahrenheit, to cause the popcorn to pop within a reasonable time. The top of the higher air outlet 38 preferably includes a vented cover 44 so that popcorn kernels are not sized to enter the higher air outlet 38. The popcorn popper 10 may include an on/off switch, if desired.

A heating plate 50 may be included that provides sufficient heat, such as between 400 and 460 degrees Fahrenheit, to pop the popcorn. When including a heating plate 50, the blower preferably excludes the heating element included therein. In this manner, the heating plate 50 provides the heat while the blower provides the air to circulate the popcorn.

A popping section 60 is positioned on top of the base section 30, and preferably permanently affixed thereto or detachably engaged therewith. The popping section 60 is preferably oval or circular in cross section, and in particular a popcorn holding section is preferably oval or circular in cross section. The popping section 60 preferably has an internal conical section 62 in which popcorn kernels 64 are located for popping. The conical section 62 tends to align the popcorn kernels 64 with the higher air outlet 38 for a more even and consistent popping of the popcorn kernels 64. With a sufficient amount of popcorn kernels 64 in the conical section 62 of the popcorn popper 10, the air and heat may be applied with a sufficient heat for a sufficient duration to tend to pop the popcorn. As the popcorn pops, it will tend to fill up the conical section 62 and the popping section 60, thereby forcing the popcorn through a horizontal section 90 defined by a removable top cover 100.

The top cover 100 is preferably supported by and readily detachable from the popping section 60. The top cover 100 preferably includes a popcorn receptacle 102. The popcorn receptacle may include one or more openings 104 defined therein that are sized of a suitable size such that popcorn kernels may freely pass through. In one embodiment, the popcorn kernels may be poured into the popcorn receptible 102, pass through the openings 104, and into the conical section 62 for subsequent popping. This provides a convenient manner of adding popcorn kernels to the popcorn popper with the top cover 100 being positioned on the popping portion. A lid 106 may be placed over the popcorn receptacle 102, if desired, to reduce the likelihood of popped popcorn coming out of the popcorn receptacle 102.

The top cover 100 may also include a plurality of vertical projections 110, preferably elongate in nature, that extend into the popcorn receptacle 102. The vertical projections 110 are preferably relatively sharp on the top thereof.

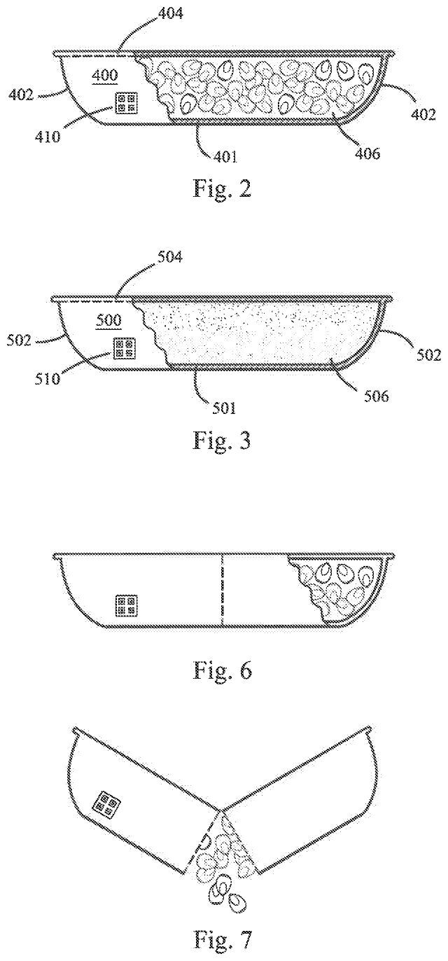

Referring to FIG. 2, a single serve portion of popcorn, may be included within a sealed paper popcorn container 400. The sealed paper container may include a base 401 with sides 402, and a detachably sealed lid portion 404. The sealed paper popcorn container 400 includes popcorn kernels therein 406. The sealed paper popcorn container 400 is sized to be suitable to fit, preferably completely, within the popcorn receptible 102. After placing the sealed paper popcorn container 400 within the popcorn receptible 102, the lid 106 is pressed down on the sealed paper popcorn container 400, thereby pressing the paper into the relatively sharp vertical projections 110 which opens up the sealed paper popcorn container 400. With the sealed paper popcorn container 400 opened, the popcorn kernels fall into the popcorn popper for subsequent popping. The sealed paper popcorn container 400 maintains the popcorn kernels fresh until they are used by the popcorn popper. In addition, a suitable amount of popcorn kernels are provided to the popcorn popper so that it is not overfilled, resulting in excessive burned kernels, or not underfilled, resulting in an increased number of non-popped kernels. Furthermore, different types of popcorn may be included within the sealed paper popcorn container 400. For example, the popcorn kernels may include white popcorn, yellow popcorn, hulless popcorn, butterfly popcorn, snowflake popcorn, ladyfinger popcorn, red popcorn, blue popcorn, purple popcorn, etc. In this manner, the user may select among the different varieties of popcorn kernels by selecting the appropriate sealed paper popcorn container 400.

The sealed paper popcorn container 400 may include markings thereon, such as in the form of a QR Code or a bar code 410, that is read by the popcorn popper using an integrated scanner 420, shown in FIG. 1, to determine the type of popcorn that is included within the sealed paper popcorn container 400. Based upon the scanner code, the popcorn maker may modify the temperature applied to the kernels for optimum popping. Based upon the scanner code, the popcorn maker may modify the airflow applied to the kernels for optimum popping. Based upon the scanner code, the popcorn maker may modify the duration of the airflow applied to the kernels for optimum popping and accordingly include automated shutoff when the popcorn kernels are likely to be fully popped. Based upon the scanner code, the popcorn maker may modify the duration of the heat applied to the kernels for optimum popping and accordingly include automated shutoff when the popcorn kernels are likely to be fully popped. Based upon the scanner code, the popcorn maker may modify the temporal airflow applied to the kernels for optimum popping and vary the amount of airflow over time. Based upon the scanner code, the popcorn maker may modify the temporal heat applied to the kernels for optimum popping and vary the amount of heat over time. These variations assist in ensuring more optimum popping of the particular popcorn kernels, which is especially suitable for popcorn kernels that are heavy and large versus popcorn kernels that are light and small.

Referring again to FIG. 1, the horizontal section 90 directs the popped kernels toward a removable container 300. The top cover 100 may include a seasoning receptible 202. The seasoning receptible 202 may include a lid 204 that encloses the seasoning receptible 202. Seasoning may be directly included within the seasoning receptible and thereafter dispensed onto the popped kernels. The seasoning receptible may include openings and relatively sharp vertical projections 210.

Referring to FIG. 3, it is preferable that seasonings are included within a sealed paper seasoning container 500. The sealed paper seasoning container 500 may include a base 501 with sides 502, and a detachably sealed lid portion 504. The sealed paper seasoning container 500 includes seasoning 506 therein. The sealed paper seasoning container 500 is sized to be suitable to fit, preferably completely, within the seasoning receptible 202. After placing the sealed paper seasoning container 500 within the seasoning receptible 202, the lid 204 is pressed down on the sealed paper seasoning container 500, thereby pressing the paper into the relatively sharp vertical projections 210 which opens up the sealed paper seasoning container 500. With the sealed paper seasoning container 500 opened, the seasoning falls into the popcorn popper for subsequent seasoning. The sealed paper seasoning container 500 maintains the seasoning fresh until it is used by the popcorn popper. In addition, a suitable amount of seasoning is provided to the popcorn popper so that it is not over seasoning, resulting in excessive seasoning, or not under seasoning, resulting in insufficient seasoning. Furthermore, different types of seasoning may be included within the sealed paper seasoning container 500. For example, the seasoning may include butter, grated parmesan, lemon, pepper, sugar, salt, old bay, truffle salt, sale, bacon, ghee, mustard seeds, chili powder, parsley, chives, tarragon, thyme, peanut, etc. In this manner, the user may select among the different varieties of seasoning by selecting the sealed paper seasoning container 500.

The sealed paper seasoning container 500 may include markings thereon, such as in the form of a QR Code or a bar code 510, that is read by the popcorn popper using an integrated scanner 520, as shown in FIG. 1, to determine the type of seasoning that is included within the sealed paper seasoning container 500. Based upon the scanner code, the popcorn maker may modify the temperature applied to the popped kernels for optimum seasoning. Based upon the scanner code, the popcorn maker may modify the airflow applied to the popped kernels for optimum seasoning. Based upon the scanner code, the popcorn maker may modify the duration of the airflow applied to the popped kernels for optimum seasoning. Based upon the scanner code, the popcorn maker may modify the duration of the heat applied to the popped kernels for optimum seasoning. Based upon the scanner code, the popcorn maker may modify the temporal airflow applied to the popped kernels for optimum seasoning and vary the amount of airflow over time. Based upon the scanner code, the popcorn maker may modify the temporal heat applied to the popped kernels for optimum seasoning and vary the amount of heat over time. These variations assist in ensuring more optimum seasoning of the popcorn, which is especially suitable for popcorn that is large versus popcorn that is small.

Referring again to FIG. 1, the removable container 300 is preferably sized to be sufficient to hold all of the popped popcorn from the sealed paper popcorn container 400. The removable container 300 preferably slides in and out from under the top cover 100. The removable container 300 also has a top sized to make a substantially sealed engagement with the top cover 100 so that there exists no open space sufficient that a kernel of popcorn could exit the popcorn popper 100 without the removable container 300 being removed from the popcorn popper 100. The removable container 300 preferably includes a handle 302. As it may be observed, the popcorn popper 100 forms a ‘closed path’ for the popcorn kernels so there is no opportunity for popcorn kernels to escape. The popcorn is placed within the popcorn receptacle 102 and sealed with the lid 106, and the seasoning is placed within the seasoning receptacle 202 and sealed with the lid 204, the removable sealed paper container of kernels and/or seasoning is located below the lid 106 and/or 204, and thereby the popcorn path is controlled in a manner that doesn't result in spillage of the popcorn while at the same time controlling the amount of popcorn provided and the seasoning provided.

The top cover 100 may include small openings therein to allow some hot air to exit, while being small enough not to permit popcorn kernels to exit the top cover.

The seasoning may be distributed onto the popped popcorn by action of the flow of air, which tends to provide a relatively uniform coating.

Preferably the seasoning receptacle 202 is designed such that it does not come into touch (or substantially in touch) with the seasoning during the dispensing processes from the seasoning package. In this manner, the vertical bars are omitted as a manner of breaking through the seasoning package. In this manner, the dispensing outlet opening of the seasoning package is self-contained within the seasoning package.

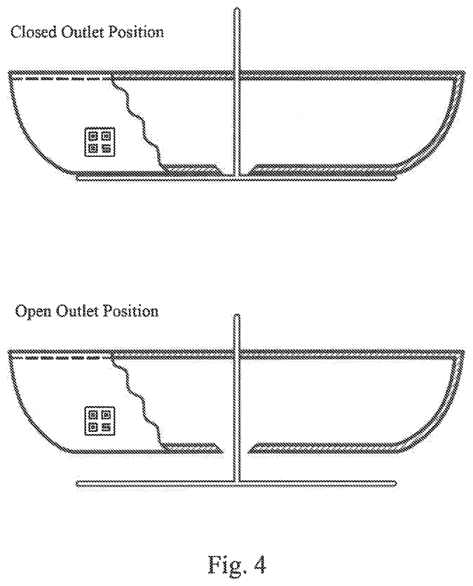

Referring to FIG. 4, in one configuration, a seasoning package may be configured for manual dispensing by the user. The manual dispensing may be performed either for a dry dispensing (i.e. dry seasoning) or a wet dispensing (i.e. wet/liquid seasoning). In one embodiment, for the wet dispensing or the dry dispensing, the seasoning receptacle allows for a portion of the seasoning package to rotate (or otherwise move with respect to the seasoning package) such that the seasoning is selectively pouring down onto the popcorn. For example, a rotational member that includes openings defined therein on a lower portion thereof may be rotatably interconnected with the seasoning package that includes openings defined therein in a lower portion thereof. By rotation of the rotational member the openings may be selectively at least partially aligned with one another to selectively permit the seasoning to pour down on the popcorn. The rotational member may further include a pushed down position/a pulled up position to selectively permit seasoning to selectively pour down on the popcorn, by creating an opening between the rotational member and the seasoning package. The lower portion of the rotational member may be positioned on the interior of the seasoning package or alternatively the lower portion of the rotational member may be positioned on the exterior of the seasoning package.

In another embodiment, a manual wet dispensing technique may include a cap in the form of a pump. When the pump is placed and secured to the top of the seasoning receptacle 202 it forms a substantially airtight seal and the wet seasoning is selectively pumped onto the popcorn.

The start time of an automatic dispensing technique may be triggered based upon a switch that indicates start of the flow of popcorn kernels into the storage container, such as based upon a temporal delay. The start time of an automatic dispensing technique may be triggered based upon an activating switch that senses sufficient accumulation of popcorn kernels in the popping side.

The dispensing technique, whether automatic or manual, may include multiple settings that determine the amount of seasoning that is provided. For example, the settings may include low seasoning, medium seasoning, and high seasoning. For example, the settings may be based upon a switch selection.

In another embodiment, the automatic dispensing technique may be air activated, where the force of the air on a rotary wheel with side notches rotate the rotary wheel and that motion causes pouring/dripping of seasoning from a cone shaped seasoning package via gravity force. The amount of the air flow may define the amount of seasoning dispensed. If the cone shaped seasoning packet is not rotating, no seasoning is dropping. The cone shaped seasoning package may have a pull out tip, and when in pull out position, the dispensing opening is created.

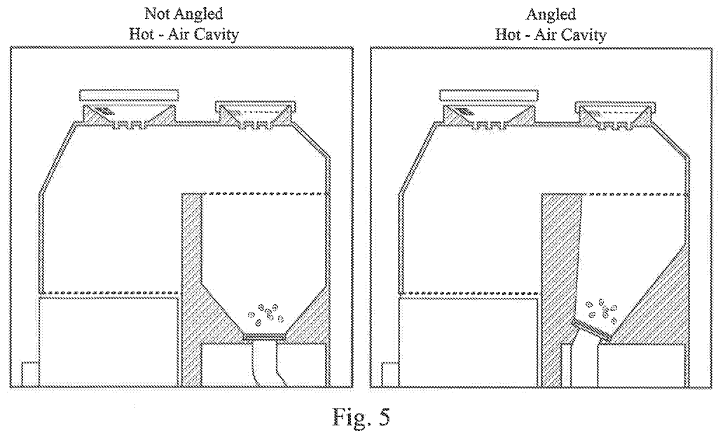

Referring to FIG. 5, one of the issues with hot-air popcorn machines is the amount of wasted un-popped kernels. The upward airflow in the machine tends to blow the un-popped kernels upward and some of them will fall into the storing container side depending on the height of the separation wall between right and left containers. The height of this separation wall has limits because if it is too high an insufficient amount of the popped kernels will cross over the separation wall. To increase the amount of popped kernels crossing the separation wall, while limiting the amount of un-popped kernels crossing the separation wall, it is desirable that the hot-air channel has an angle (0+ to 45 degrees) away from the storage container. The combination of gravity and angle of un-popped kernels flow will reduce the amount of un-popped kernels that are crossed into the storage container.

In some embodiments, the lack of a seasoning package may be sensed using an electrical and/or a mechanical sensing structure. In some embodiments, the lack of a popcorn package may be sensed using an electrical and/or a mechanical sensing structure. For example, one sensing structure may include one or more magnets that detect the presence of the seasoning package and/or popcorn package. The device may include an interlock mechanism such that the popcorn popper does not turn on until the seasoning package and/or popcorn package are engaged with the popcorn popper. The device may include an interlock mechanism such that the popcorn popper does not provide any hot air and/or sufficient hot air until the seasoning package and/or popcorn package are engaged with the popcorn popper. The device may include an interlock mechanism such that the popcorn popper automatically turns on when the seasoning package and/or popcorn package are engaged with the popcorn popper.

In another embodiment the electrical blower 34 in FIG. 1 has multiple blowing speeds. One blowing speed is used during the period in which the kernels are getting heated to get popped under higher temperature and subsequently get transferred to the container 300 through the spacing 90. The second blowing speed is used in the post popping process to push any unpopped kernels over to the container 300. This higher blowing speed is used for an automatic cleaning process, clearing any unpopped kernels from the heating cavity. The switch between the lower speed blowing and higher speed blowing could be automatic and time based, and/or be a manual process based on a cleaning switch.

Referring to FIG. 6, the sealed paper container may have a dividing line at substantially the middle thereof which is in a closed position when not in use.

Referring to FIG. 7, upon receiving pressing engagement on the top thereof, the sealed paper container will cause the dividing line to break open and release the popcorn kernels contained therein. The sealed popcorn container may have built in horizontal extensions to be used as a resting position on the cavity receptor. The popping receptacle may have a corresponding sloped resting position such that in an opened position, the sealed container will be resting on these interior sidings and the container will not fall into the unit.

In another embodiment, an automatic dispensing technique may be based on a pressurized gas cartridge, including for example Nitrous Oxide, that is used to spray the seasoning over the popcorn. The pressurized gas cartridge may be a disposable cartridge that is replaced as it runs out after multiple uses. The cartridge may contain both the seasoning and the pressurized gas. The pressurized gas cartridge may be separate from the seasoning container.

In another embodiment, the automatic dispensing technique may be based on a syringe type POD where the syringe type POD has a sealed container with sealed upper moving valve. When the sealed valve is mechanically pushed down, the wet seasoning is squeezed out of the other end of the container through a spray head that is designed to spray the seasoning evenly down on the popcorn in the popcorn container as the popcorn is filling into the container. In one embodiment, the mechanical movement used to move the valve may come from a DC based motor built into the seasoning dispenser module.

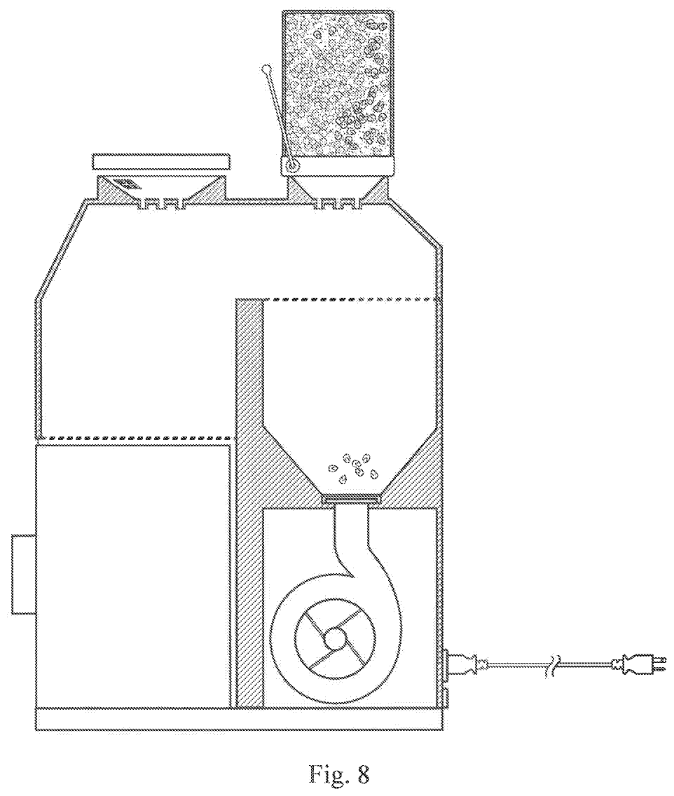

Referring to FIG. 8, in another embodiment, a bulk amount of popcorn may be included in a bulk container designed for multiple popcorn servings. The bulk serving container may have a common attachment interface mechanism with the top cover as the single popcorn container 400, such that, the single serve popcorn container and the bulk serving container are interchangeable. In addition, the bulk serving popcorn container also has a built-in mechanism that will release a certain amount of popcorn sufficient for a single popcorn serving. This release mechanism could be a mechanical actuator or based on an electric actuator.

In another embodiment, the popping unit may have multiple bulk popcorn containers, each filled with same or different variety of popcorn kernel, in this manner the user can choose from varieties of popcorn as available in the bulk containers.

In one embodiment the multiple bulk containers may be stationed on different popcorn receptors, each having their own receptor. In another embodiment, the bulk containers may sit on a rotary platform and rotate into the same receptor opening on the unit.

In another embodiment, the popping unit may have a bulk amount of seasoning in a bulk seasoning container designed for multiple popcorn servings. The bulk seasoning dispenser may have a common attachment interface mechanism with the top cover as the single popcorn container 400, such that, the single popcorn container and the bulk popcorn container are interchangeable. In addition the bulk popcorn container, also has a built-in mechanism that will release a certain amount of popcorn sufficient for a single popcorn serving. This release mechanism could be a mechanical actuator or based on an electric actuator.

In another embodiment, the popping unit may have multiple seasoning dispensing modules, each able to dispense a separate type of seasoning. The dispensing modules could be on a rotating platform that when turned, will allow for alignment of the selected dispensing module with the seasoning receptor on the unit. In another embodiment each of the seasoning dispensing modules could have their own receptor.

In another embodiment, with multiple popcorn kernel dispensing and/or multiple seasoning dispensers, there may be a mechanical and/or electrical selection panel to select the type of kernel and/or the type of seasoning for a serving cycle.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. A popcorn popper for popping popcorn kernels comprising:
(a) a base section that includes an electrical blower that receives air from an inlet from a location exterior to said popcorn popper and provides air through an air outlet;
(b) a popping section that is positioned in a manner to receive said air provided through said air outlet of said base section and suitably sized for said popping said popcorn kernels in response to receiving sufficient heat together with said received air;
(c) a transfer section that receives said popped popcorn kernels from said popping section, said transfer section defining a popcorn receptacle suitably sized to support non-popped popcorn kernels thereon, said transfer section defining a seasoning receptacle suitably sized to support seasoning popped popcorn thereon;
(d) a removable container that receives said popped popcorn from said transfer section.

2. The popcorn popper of claim 1 wherein said electrical blower includes a rotational set of blades.

3. The popcorn popper of claim 1 wherein said electrical blower provides heated air at a temperature between 400 and 460 degrees Fahrenheit.

4. The popcorn popper of claim 1 further comprising a heated plate in contact with said popcorn kernels.

5. The popcorn popper of claim 1 wherein said popping section is positioned above said base section and defines a circular interior cavity suitable to hold said popcorn kernels.

6. The popcorn popper of claim 1 wherein said transfer section defines a horizontal cavity through which said popped popcorn passes prior to being contained by said removable container.

7. The popcorn popper of claim 1 wherein said transfer section is detachably supported by said popping section.

8. The popcorn popper of claim 1 wherein said popcorn receptacle defines a plurality of openings therein suitable to permit said non-popped popcorn kernels to pass therethrough and substantially preventing popped popcorn from passing therethrough.

9. The popcorn popper of claim 1 wherein said popcorn receptacle includes a detachable popcorn receptacle lid.

10. The popcorn popper of claim 1 wherein said popcorn receptacle includes a plurality of vertical projections defined therein suitable to penetrate a popcorn container including non-popped popcorn kernels therein such that said non-popped popcorn kernels can fall into said popping section upon penetrating said popcorn container.

11. The popcorn popper of claim 1 further comprising a popcorn container that includes said non-popped kernels popcorn therein suitable to be supported within said popcorn receptacle.

12. The popcorn popper of claim 11 further comprising a lid in selective pressing engagement with said popcorn container suitable to cause said popcorn container to break open causing said non-popped popcorn kernels therein to fall into said popping section.

13. The popcorn popper of claim 12 further comprising a code on said popcorn container, said popcorn popper include a scanner that reads said code on said popcorn container to identify the type of said non-popped popcorn kernels contained within said popcorn container.

14. The popcorn popper of claim 13 wherein the temperature of said heat is modified based upon said identified type of said non-popped popcorn kernels contained within said popcorn container.

15. The popcorn popper of claim 14 wherein a speed of said air provided through said air outlet is modified based upon said identified type of said non-popped popcorn kernels contained within said popcorn container.

16. The popcorn popper of claim 1 wherein said seasoning receptacle defines a plurality of openings therein suitable to permit said seasoning to pass therethrough and substantially preventing popped popcorn from passing therethrough.

17. The popcorn popper of claim 1 wherein said seasoning receptacle includes a detachable seasoning receptacle lid.

18. The popcorn popper of claim 1 wherein said seasoning receptacle includes a plurality of vertical projections defined therein suitable to penetrate a seasoning container including seasoning therein such that said seasoning can fall into said removable container upon penetrating said seasoning container.

19. The popcorn popper of claim 1 further comprising a seasoning container that includes said seasoning therein suitable to be supported within said seasoning receptacle.

20. The popcorn popper of claim 19 further comprising a lid in selective pressing engagement with said seasoning container suitable to cause said seasoning container to break open causing said seasoning therein to fall into said removable container.

21. The popcorn popper of claim 20 further comprising a code on said seasoning container, said popcorn popper include a scanner that reads said code on said seasoning container to identify the type of said seasoning contained within said seasoning container.

22. The popcorn popper of claim 21 wherein the temperature of said heat is modified based upon said identified type of said seasoning contained within said seasoning container.

23. The popcorn popper of claim 22 wherein a speed of said air provided through said air outlet is modified based upon said identified type of said seasoning contained within said seasoning container.

24. The popcorn popper of claim 1 further comprising a seasoning container that includes said seasoning therein suitable to be supported within said seasoning receptacle, where said seasoning is selectively removed from said seasoning container by selective movement of a member in contact with said seasoning.
